(19) United States
(12) Patent Application Publication
(10) Pub. No.: US 2009/0167049 A1
(43) Pub. Date: Jul. 2, 2009

(54) Vehicle cover

(76) Inventor: Ian P. Lariviere, Ludlow, MA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/003,479

(22) Filed: Dec. 26, 2007

(51) Int. Cl. B60J 11/02; B60J 11/04

(52) U.S. Cl. 296/98; 296/136.13

(57) ABSTRACT

The vehicle cover includes a frame assembly having both vertical and lateral adjustment for supporting a tarp roll laterally thereon. The frame assembly is temporarily installed atop the vehicle, with forward and rearward anchors being installed laterally beneath the respective forward and rearward ends of the vehicle. A tarp or cover is unrolled from the tarp roll atop the frame assembly, and attached to the forward and rearward anchors to form a tent-like configuration having relatively steep forward and rearward slopes and near vertical sides. This configuration greatly improves the shedding of snow, ice, and leaves and other debris that would otherwise collect atop a cover resting directly atop the relatively flat surfaces of the vehicle. The entire frame and cover assembly remain clear of the underlying surface and contact only the vehicle, and are thus not considered permanent structures that might be subject to zoning or other local regulations.

### BACKGROUND OF THE INVENTION

1. Field of the Invention

The present invention relates generally to temporary, portable protective covers for vehicles and the like. More specifically, the present invention is a vehicle cover having a roof-mounted frame that lifts the center of the cover well above the vehicle, and provides steeply sloping cover surfaces for shedding snow, leaves, etc.

2. Description of the Related Art

Most owners and operators of automobiles, light trucks, etc. prefer to protect and shelter their vehicles from the elements, if at all possible. This is particularly true in more northern portions of the country, where snow and freezing rain are normal occurrences in the winter. Yet, not everyone has access to a permanent storage structure, such as a garage, shed, or the like, for various reasons.

As a result, vehicle owners and operators will often tie a simple tarp over any otherwise exposed vehicles to provide some level of protection from the elements. Tarps are relatively inexpensive, although they are cumbersome to install and remove and do not provide optimum protection for the article secured therebeneath. A better solution is a specially made vehicle cover, particularly one which is shaped to conform to the dimensions and contours of the particular make and model of vehicle with which the cover is intended to be used. Such covers provide more complete protection and are generally less cumbersome to install and remove than a loosely fitting tarp or the like, although they are more costly than an unfitted tarp.

The installation of a simple tarp or form-fitting vehicle cover over the vehicle, results in nearly all of the cover resting directly upon the surface of the vehicle. As most vehicle roofs, engine compartment hoods, and trunk lids are relatively flat and level, with only slight curvature, this can allow the buildup of snow and/or other debris upon the cover directly over these surfaces. The problem is magnified when a tarp or other cover is installed over a pickup type vehicle with an open bed, where snow, water, and/or other debris can collect on the cover over the bed of the vehicle and cause the cover to sag downwardly into the bed, thereby forming a large pocket that collects even more snow, water, and/or debris.

Thus, a vehicle cover solving the aforementioned problems is desired.

### SUMMARY OF THE INVENTION

The vehicle cover includes a frame temporarily installed atop the roof of the vehicle, forward and rearward anchors disposed laterally beneath the respective ends of the vehicle, and a tarp or cover sheet deployed from the frame and extending downwardly to wrap around the front and rear of the vehicle and attach to the two anchors. The frame includes left and right side uprights that may be extended in height as desired to support a lateral tarp roll tube or pipe assembly thereacross. The additional height of the tarp roll tube above the roof of the vehicle results in a steep forward and rearward slope of the tarp from the tarp roll tube to the respective front and rear ends of the vehicle, with the steep slope serving to shed snow, rain, leaves, and/or other debris more readily than a conventional cover.

The vehicle cover further includes lateral adjustment to accommodate vehicles of different sizes, with the rolled tarp or cover sheet accommodating different vehicle lengths according to the amount or degree that the tarp is unrolled. The tarp is cut or configured to provide essentially complete coverage of the top and ends of the vehicle, and at least the upper sides of the vehicle as well. The cover is supported completely by the vehicle to which it is attached, with none of the cover components being supported by the underlying surface or other structure. Thus, the present vehicle cover is considered a temporary cover or shelter, and is not subject to zoning or other ordinances affecting structures that are attached at least partially to the ground or other surface underlying the vehicle.

These and other features of the present invention will become readily apparent upon further review of the following specification and drawings.

### BRIEF DESCRIPTION OF THE DRAWINGS

FIG. 1 is an environmental, perspective view of a vehicle cover according to the present invention, showing the cover deployed upon a vehicle.

FIG. 2 is a perspective view of the frame assembly of the cover, installed upon a vehicle.

FIG. 3 is a front elevation view of the frame assembly, showing the adjustable and folding features thereof.

FIG. 4 is a detailed perspective view in partial section of one of the tarp roll support members, showing further details thereof.

FIG. 5 is a schematic side elevation view of the tarp roll assembly, showing its operation.

FIG. 6 is a broken away perspective view of the front and rear anchor assemblies, showing their installation on a vehicle.

FIG. 7 is a perspective view showing the operation of the temporary support of the tarp roll assembly during deployment of the cover.

FIG. 8 is a top plan view of the tarp used with the present vehicle cover.

Similar reference characters denote corresponding features consistently throughout the attached drawings.

### DETAILED DESCRIPTION OF THE PREFERRED EMBODIMENTS

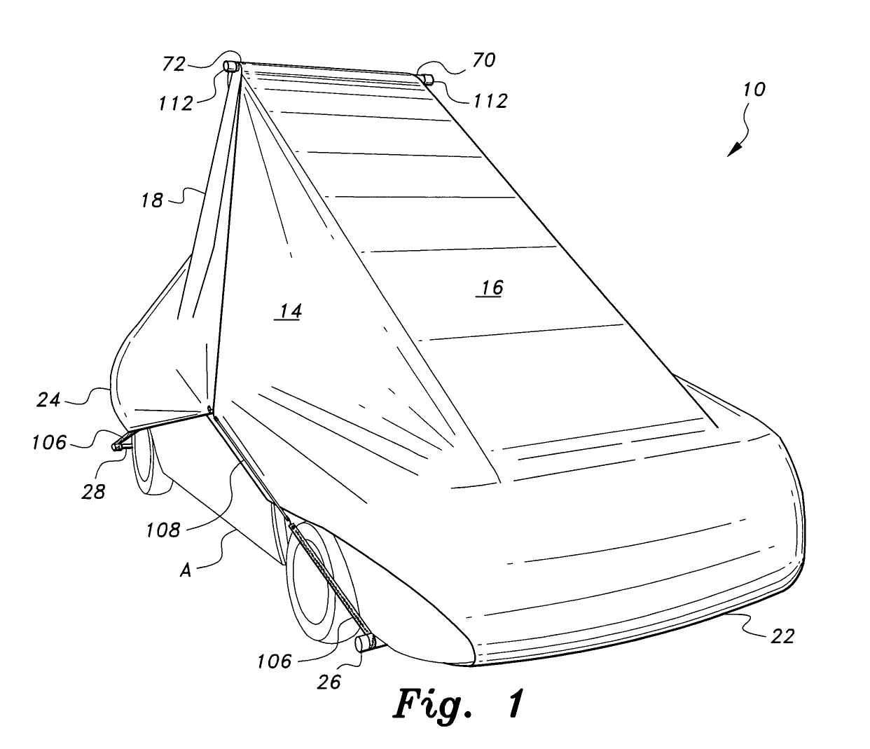

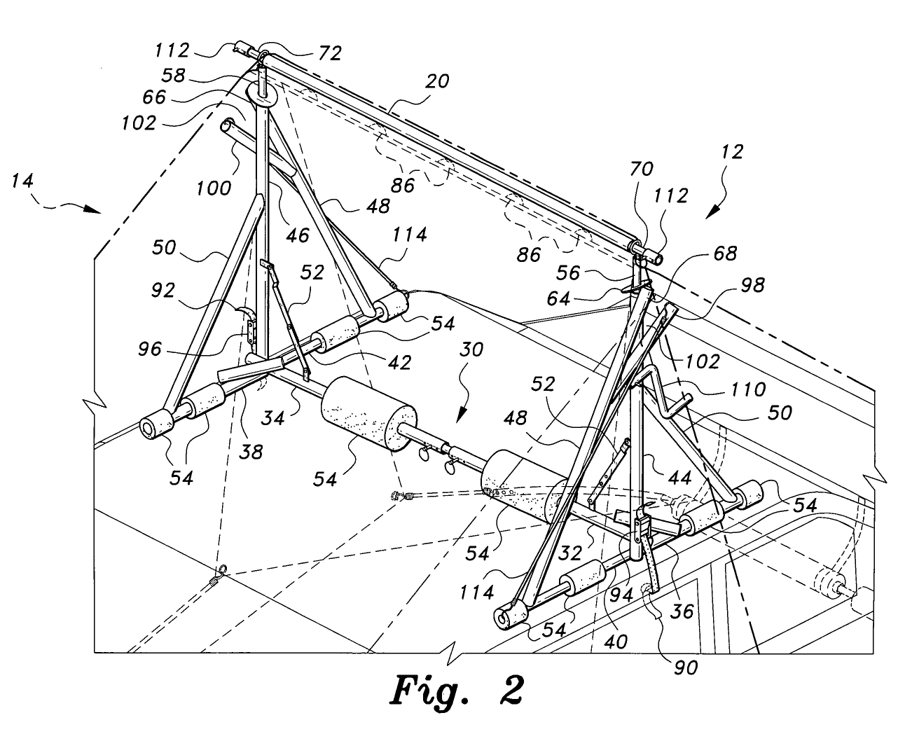

The present invention is a vehicle cover having a rigid frame that mounts removably atop the vehicle, to support the center of the cover high above the vehicle and provide steeply sloping forward and rearward cover surfaces to shed snow, leaves, and other debris. FIG. 1 provides a general perspective view of the vehicle cover assembly 10 installed upon an automobile A. The cover assembly 10 includes a frame 12 (shown in detail in FIG. 2 and discussed further below), with a cover 14 having opposite forward and rearward panels 16 and 18 extending from a centrally disposed and elevated lateral cover support 20 supported by the underlying frame 12. The forward and rearward ends 22 and 24 of the cover 14 attach to respective laterally disposed forward and rearward anchor members 26 and 28 removably disposed beneath the forward and rearward ends of the automobile A or other vehicle.

FIG. 2 provides a detailed perspective view of the frame assembly 12. The frame assembly 12 includes a laterally disposed base member 30 having mutually opposed first and second ends 32 and 34, with first and second upright supports 36 and 38 extending forwardly and rearwardly respectively from the first and second ends of the base member 30. Each of the upright supports 36 and 38 comprises a central tube immovably affixed (welded, etc.) to the corresponding end 32 or 34 of the base member 30. A smaller diameter pivot tube, respectively 40 and 42, is installed within and extends beyond each end of each of the central tubular upright supports 36 and 38, and comprises the base member of the upright assembly. First and second uprights, respectively 44 and 46, are welded or otherwise immovably affixed to the respective pivot tubes 40 and 42 of each of the upright supports 36 and 38, with opposite first and second diagonal braces 48 and 50 extending from the opposite ends of the two upright supports 36 and 38 to the upper ends of the uprights 44 and 46.

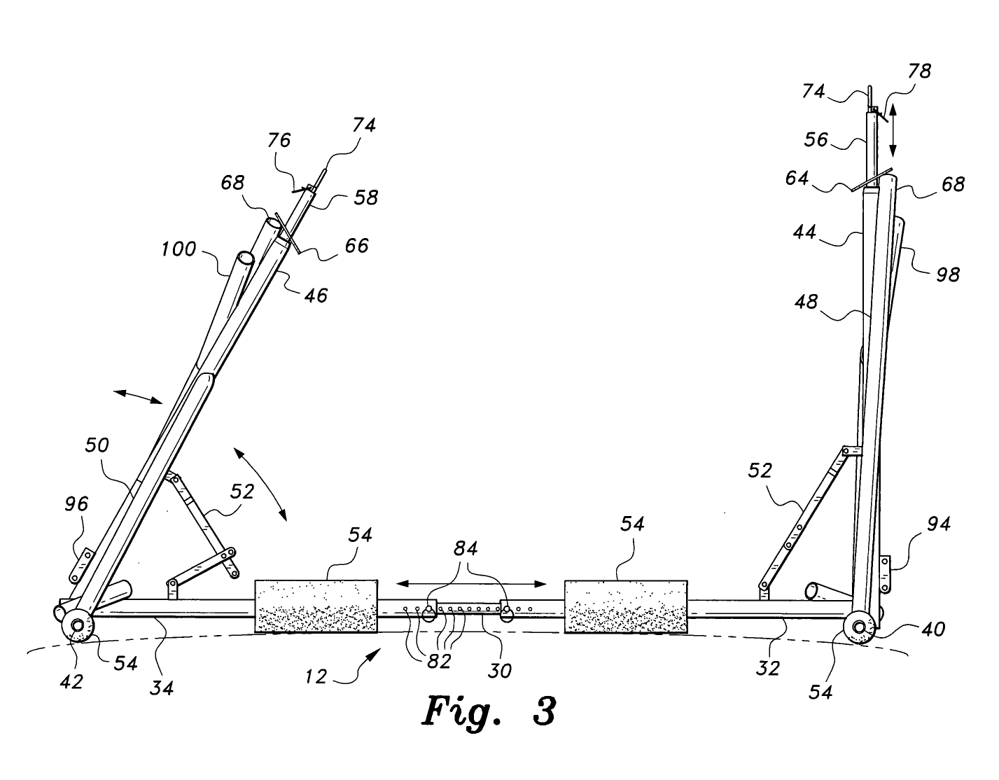

This structure allows the upright assemblies to pivot or fold downwardly adjacent to the central base member 30 for compact storage, as shown in FIG. 3 with the second upright 46 and its attached upright assembly illustrated in an intermediate position during the folding or unfolding operation. Each upright 44 and 46 and associated assembly is locked in its fully deployed upright position, as shown by the first upright 44 and assembly in FIG. 3, by a two-link locking arm 52 extending between each of the first and second end components 32 and 34 and their respective attached first and second uprights 44 and 46. The various lowermost members, i.e., the first and second ends 32 and 34 of the base member 30 and the two upright supports 36 and 38 and their corresponding pivot tubes 40 and 42, are preferably provided with padding material 54 (sleeves, collars, etc.) thereon in order to preclude marring of the finish of the automobile or vehicle A.

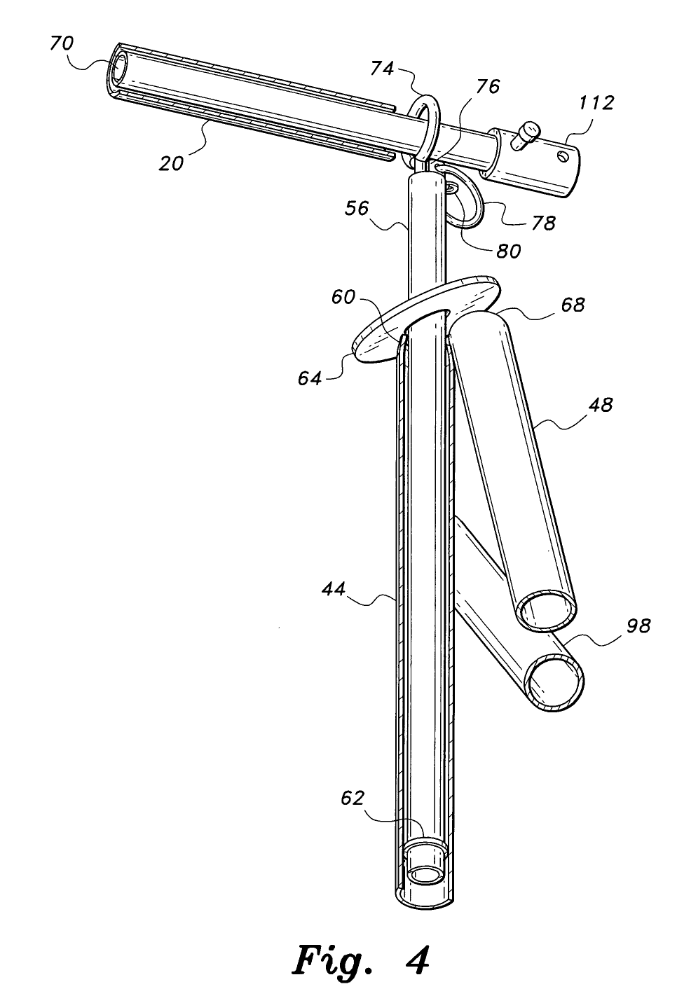

Each of the two uprights 44 and 46 supports an opposite end of the cover support member 20 thereon, with the cover support 20 raised well above the top of the automobile A or other vehicle when the present vehicle cover assembly 10 is installed and erected thereon. While the cover support 20 may be removably installed directly atop each of the uprights 44 and 46, preferably each of the uprights includes a telescoping tubular extension, respectively 56 and 58, therein to allow the height of the cover support (and thus the ridge line of the cover 14) to be adjusted as desired. This height adjustment mechanism for the cover support 20 is shown at least generally in several of the drawings, but is shown in greatest detail in the view of FIG. 4 showing the first upright 44 and its associated structure. The first upright 44 includes a first upright extension 56 captured therein and extending from the upper end thereof. The upper ends of each upright 44 and 46 includes a crimp 60 or other restriction, with the lowermost end of each extension 56 and 58 having a stop 62 (e.g., washer, etc.) thereon to preclude separation of the extension member from its corresponding upright. While only a single upright extension member is shown with each of the uprights 44 and 46, it will be seen that multiple telescoping extension members may be used to provide even greater height extension for the cover support 20, if so desired.

First and second lock rings 64 and 66 are disposed about the respective upright extensions 56 and 58, above the crimped upper ends of the respective first and second uprights 44 and 46. It will be noted in FIG. 4 that the upper end 68 of the first diagonal brace member 48 is attached non-concentrically to the upper end of the first upright 44, and extends slightly above the crimped upper end of the upright 44. This higher upper end 68 of the first diagonal contacts the lock ring 64 to one side thereof, causing the lock ring to take a cant relative to the concentric axes of the upright 44 and its extension 56. This results in the central passage of the ring 64 gripping the side of the extension member 56, thus locking the extension member to prevent its retraction into the upright 44.

Adjustment of the extension 56 is easily accomplished by raising the extension slightly to disengage the lock, and holding the lock ring 64 in a plane substantially normal to the axes of the upright 44 and its extension 56. This allows the extension 56 to slip through the central passage of the lock ring 64 for extension or retraction as desired, with the lock ring 64 then being repositioned to rest at a cant upon the upper end 68 of the diagonal 48 and grip the extension 56 passing therethrough. The opposite second upright 46, extension 58, diagonal 48, and lock ring 66 operate in the same manner. Other height locking means for the extensions 56 and 58 may be provided alternatively, e.g., cutting the upper ends of the two uprights 44 and 46 at an angle to cause the lock rings 64 and 66 to rest at a cant thereon, etc.

FIG. 4 also provides a detailed illustration of the removable installation of the cover support 20 to the upper end of the first extension 56. The installation of the cover support to the opposite second extension is the same. The cover support 20 comprises a central tubular member, with opposite first and second telescoping extension members 70 and 72 extending therefrom. The first cover support extension 70 is shown in FIG. 4, with its outermost portion passing through the eye of an eyebolt 74 or the like to allow the cover support extensions 70, 72 and central cover support member 20 to rotate relative to the eyebolts 74 and underlying upright assemblies. The shank of the eyebolt 74 is inserted removably into the open upper end of the first upright extension 56 to secure the cover support 20 to the upright extension 56 and upright 44. A linchpin 76 or the like is secured to the shank of the eyebolt 74, with the ring 78 extending from the linchpin being placed about a tab 80 extending laterally from the upper end of the upright extension 56 to preclude inadvertent removal of the eyebolt 74 from the extension 56. When removal of the cover support 20 and its extensions 70, 72 from the underlying first and second upright assemblies is desired, the linchpin ring 78 is pivoted away from the tab 80 and the cover support assembly 20 is lifted upwardly to withdraw the two eyebolts 74 from the upper ends of their respective upright extensions 56 and 58.

The frame assembly of the cover may be adjusted in width as well, to accommodate vehicles of different sizes. FIG. 3 illustrates the structure providing for the adjustment of the frame base member 30 and its two end components 32 and 34. The frame base member 30 includes opposite first and second end components 32 and 34 telescopically assembled to the central base member. The frame base member 30 includes a series of locking holes or passages 82 therethrough, with the inboard ends of the end components 32 and 34 having similar passages 82. Selected ones of the passages are aligned with one another through the base member 30 and end components 32, 34, and a locking pin 84 (linchpin, etc.) is installed therethrough to secure the assembly to the desired width. This adjustment is generally only required once for fitting the frame assembly 12 of the car cover 10 to any specific vehicle make and model of vehicle.

The vehicle cover support member 20 also comprises a series of three telescoping tubes, as shown in various drawing FIGS. However, the central member 20, which supports the vehicle cover sheet 14 thereon, has a larger diameter than the two roll cover support extensions 70 and 72, which telescope into the central member 20. The larger diameter central member 20 allows the cover 14 to be rolled thereon and unrolled therefrom without interference from the sliding of the telescoping extensions 70 and 72. No length locking means is provided for this assembly, as the central member 20 is retained between the two eyebolts 74 and the extensions 70 and 72 are retained by their passages through the two eyebolts. The anchor bars or members 26 and 28 may be constructed in the same general manner, i.e., with a larger diameter central member and opposite smaller diameter telescoping extensions. The extensions are secured in the central member in the manner described further above for the two uprights 44, 46 and their extensions 56, 58.

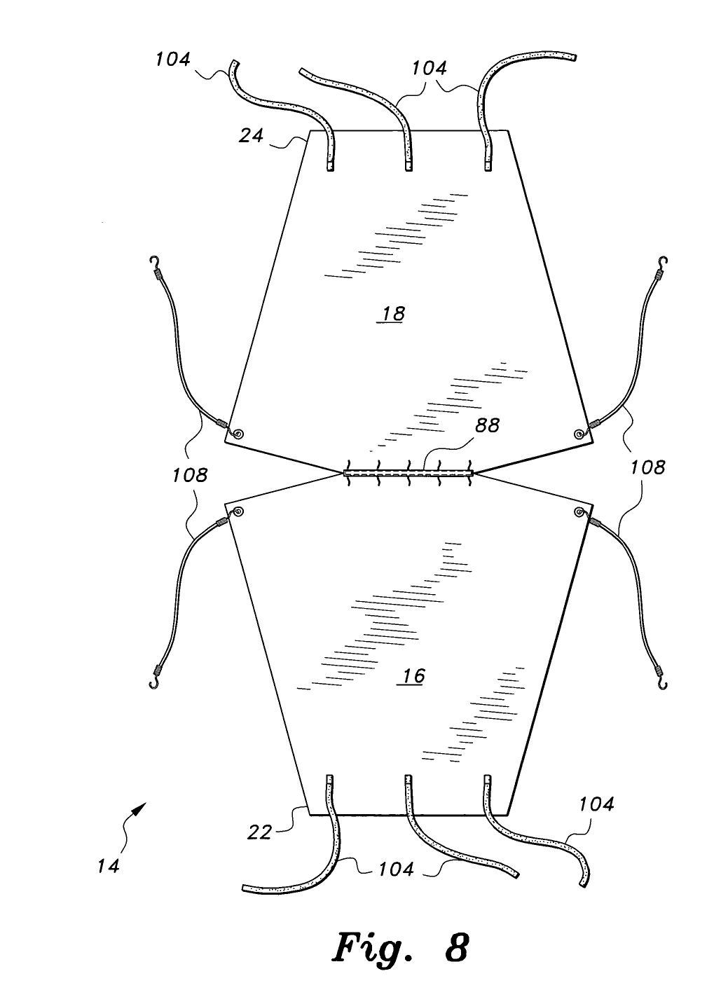

Although there are no lock pins or the like extending through or from the vehicle cover support member 20, there are a series of medial cover support attachment tabs 86 extending therefrom, as shown in broken lines in FIG. 2. The cover 14 (FIG. 8) includes a medially and laterally disposed cover support attachment 88 secured thereacross, which in turn secures to the cover attachment tabs 86 extending from the cover support member 20 and provides a stronger material to which the fasteners attach. Various means may be used to secure the cover support attachment 88 to the support member 20, e.g. self-tapping screws which engage holes in the tabs 86, plastic locking ties, etc. as desired. The attachment of the cover 14 to the support member 20 is a permanent or at least a semi-permanent installation, with the cover 14 being rolled onto the support member 20 for storage. The cover support attachment 88 of the cover 14 also serves to secure the two cover portions 16 and 18 together and reinforce the center of the cover, where some of the greatest stress in the fully extended cover is developed due to the relatively narrow width of the cover 14 at this point.

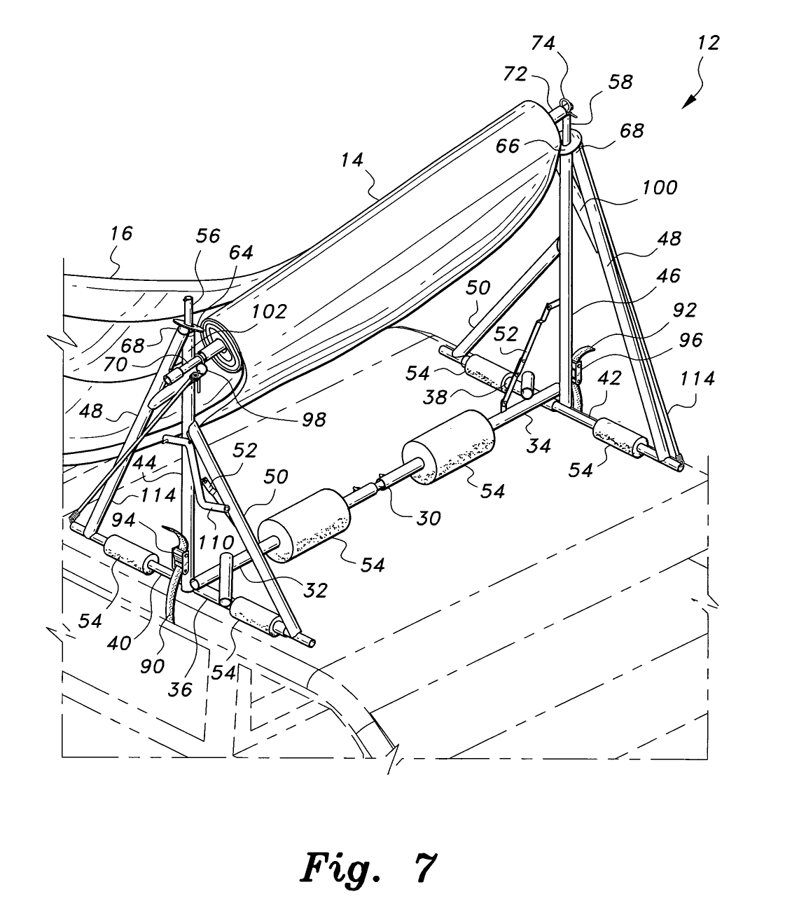

The vehicle cover 10 is installed and deployed on the vehicle by initially placing the frame 12 atop the vehicle and extending the two upright or cover roll support assemblies, generally as shown in FIG. 3 of the drawings. Any adjustment in the width of the frame base member 30 and its extensions 32 and 34 may be carried out at this time, if this has not been previously accomplished. The frame 12 is secured to the top of the vehicle by first and second door capture anchor straps, respectively 90 and 92 (see particularly FIGS. 2 and 7), which extend from first and second adjuster buckles 94 and 96 attached respectively to the first and second uprights 44 and 46. The free ends of the straps 90 and 92 are captured between the upper door frame and vehicle roof, or between the upper edge of the glass and the vehicle roof in the case of a hard top, and the straps are pulled taut and locked by means of the adjuster buckles 94 and 96. The forward and rearward anchor bars 26 and 28 may be positioned loosely beneath the forward and rearward ends of the vehicle at this time.

Once the above has been accomplished, the roll cover support member 20 with the cover 14 rolled thereon may be installed atop the first and second uprights 44 and 46 and their respective extensions 56 and 58. It will be recognized that the cover 14 is relatively bulky and heavy, and is awkward to handle during this installation step. Accordingly, the frame 12 includes additional structure to facilitate this cover roll installation. First and second supplemental cover supports 98 and 100 are attached at an angle across the respective first and second uprights 44 and 46 and their respective first diagonal braces 48. The angle between each supplemental cover support 98, 100 and its respective upright 44, 46 forms an upwardly oriented crotch or notch 102, which serves as a temporary support for one end of the cover roll assembly during erection of the cover.

Initially, the cover roll assembly, i.e., the cover support roll 20 and its extensions 70 and 72 and the cover 14 rolled upon the support roll 20, is set into place atop the frame assembly with each of the cover support extensions 70 and 72 resting temporarily in the two opposite crotches or notches 102. The installer is then free to move around to either side of the vehicle to install the appropriate eyebolt 74 in the corresponding extension end 70 or 72, as desired. FIG. 7 illustrates this operation, with the cover roll assembly being temporarily supported at its first extension end 70 within the first crotch 102 while the shank of the eyebolt 74 of the opposite second extension end 72 has been installed within the upper end of the second extension 58. The installer will then move to the opposite side of the vehicle and install that eyebolt 74 in the first extension 56 to complete the cover roll assembly installation. Additional extension of the two upright extensions 56 and 58 to steepen the slopes of the forward and rearward cover panels 16 and 18 may be accomplished either before installing the cover roll assembly eyebolts 74 in the upper ends of the extensions, or after such installation, as desired. Removal of the cover roll assembly is accomplished by reversing the above-described procedure.

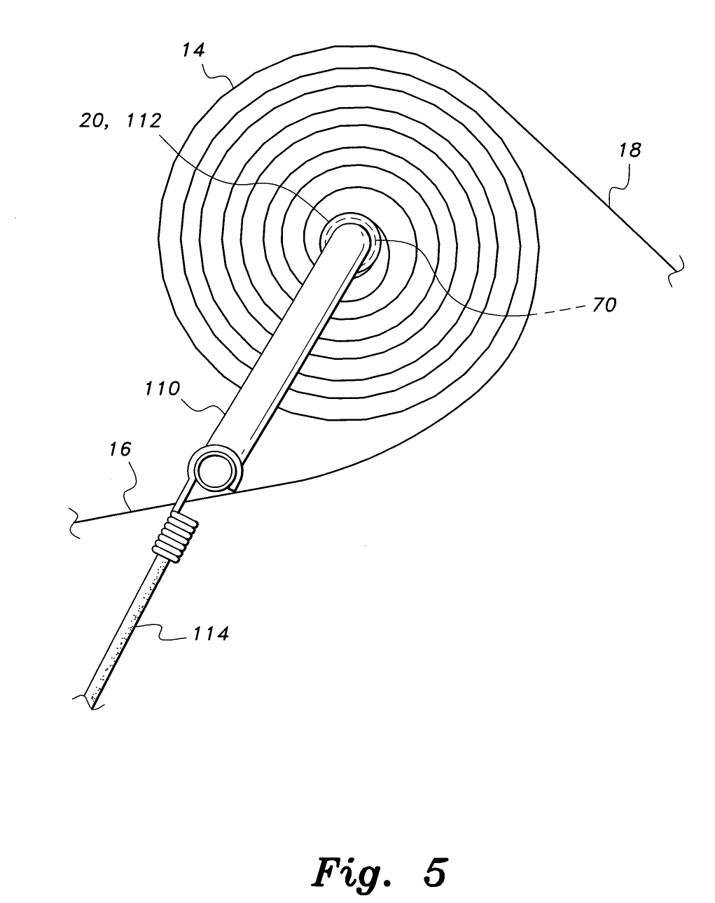

At this point, the cover 14 is unrolled from the cover support roller 20, which is free to rotate within the eyes of the two opposed eyebolts 74 placed in the upper ends of the first and second upright extensions 56 and 58. The person deploying the cover 14 need only grasp one of the two free ends of the cover and pull that end toward the appropriate end of the vehicle. As the cover 14 is attached to the support roller 20 along the medial support attachment band 88 of the cover, the cover 14 is rolled and unrolled from its center. FIG. 5 provides an illustration of this arrangement, with both the forward panel 16 and rearward panel 18 being deployed simultaneously in generally opposite directions from the central cover support roller 20.

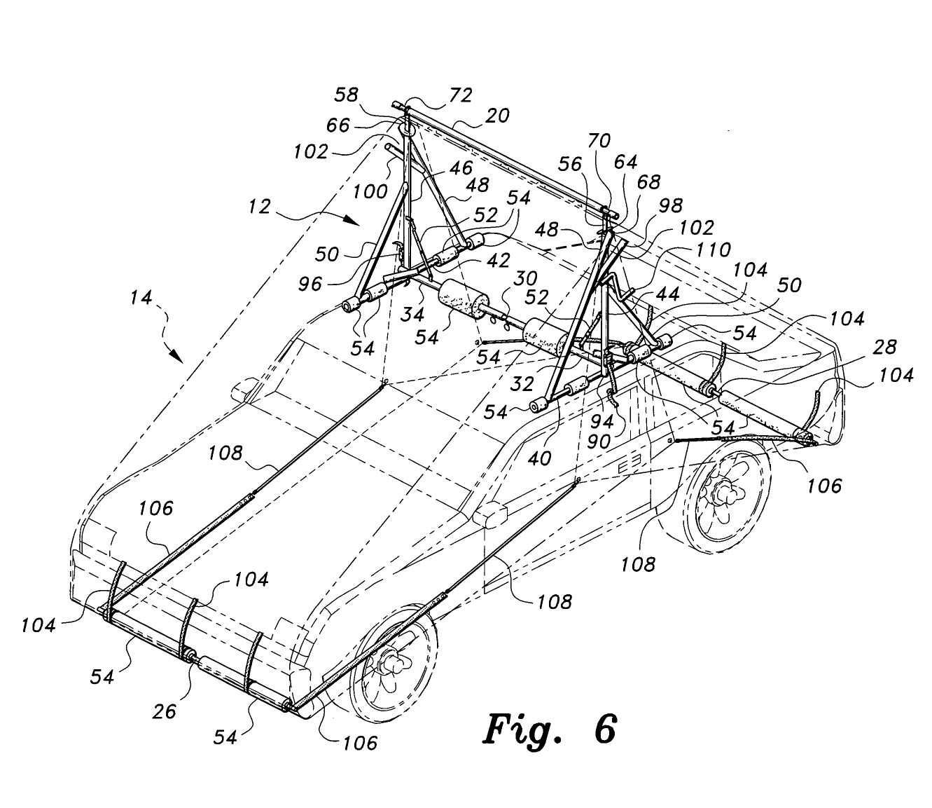

When the cover 14 has been extended over the forward and rearward portions of the vehicle as required, it is connected to the respective forward and rearward anchor bars 26 and 28 using the anchor attachment straps 104 extending from the forward and rearward ends 22 and 24 of the cover 14. These attachment straps or ties 104 are shown in the plan view of the cover 14 in FIG. 8, and are shown in use in FIG. 6 of the drawings. The two anchors 26 and 28 may include a corresponding series of attachment points, or the straps 104 may be tied around the anchor bars 26 and 28 as desired.

At this point, the anchor bars 26 and 28 are positioned beneath the respective forward and rearward ends of the vehicle, and secured in place against the underside of the vehicle and tires by using straps 106 extending from the ends of the anchors and bungee cords 108 extending from the medial corner edges of the cover 14. The plan view of the cover shown in FIG. 8 shows these bungees 108 extending from the cover, with FIGS. 1 and 6 showing the connections of these laterally deployed straps 106 and/or bungees 108 in securing the sides of the cover 14 over the vehicle or automobile A. The straps 106 extending from the two anchors 26 and 28 preferably have a series of holes therein, to accept corresponding hooks installed upon the distal ends of the cover bungees 108. These strap attachment hooks on the bungees 108 may be adjustably installed on the bungees to provide additional adjustment for the assembly if needed. It will be noted in the various drawing FIGS. that attaching and tightening the straps 106 and bungees 108 to one another, draws the sides of the cover 14 downwardly along the sides of the automobile A to provide good coverage and protection for the vehicle beneath the cover assembly 10.

In the event that excessive cover length is provided for the vehicle, the cover 14 need not be completely unrolled from its cover roll 20. However, it will be seen that the cover 14 will not remain taut over the vehicle unless some means is provided for holding the partial cover roll in place and preventing it from unwinding further. FIG. 5 illustrates a means for accomplishing this, with a crank handle 110 installed in a fitting or coupling 112 in the outboard end of the first cover support extension 70. Each of the two cover support extensions 70 and 72 may include crank fittings or couplings 112 in their distal ends, e.g., square sockets, etc., mating with the drive end of the crank 110 to lock the crank rotationally relative to the cover support extensions. The extensions 70, 72 may be locked rotationally relative to the central cover roller 20 by splines, longitudinal slots and radially disposed pins, etc.

The crank handle 110 is in turn prevented from rotating by a crank retainer bungee 114, the distal end of which is hooked to one of the ends of the first upright pivot tube 40. A series of such retainer bungees 114 may be provided and stored conveniently by securing them between the ends of the upright pivot tubes 40 and 42 and the ends of the two supplemental cover support members 98, as shown in FIGS. 2 and 7. The retainer bungees 114 may also be wound around the rolled cover 14 to prevent the cover 14 from unrolling when rolled for storage, in lieu of using the end straps 104 extending from the cover. The crank handle 110 is stored when not in use by hanging from a conventional hook or the like extending from the frame assembly 12, generally as shown in FIGS. 2, 6, and 7.

The cover assembly 10 is removed from the automobile A or other vehicle essentially by reversing the installation procedure described above. In the event that the cover 14 was not completely unwound to cover the vehicle during deployment, any locking means used to prevent the rolled cover 14 from unrolling further (e.g., retainer bungee 114) may be removed or unlatched to provide slack for loosening and removing the forward and rearward straps or ties from the corresponding forward and rearward anchor bars 26 and 28. The lateral cover retaining bungees 108 may be unhooked from their respective anchor bar straps or ties 106 at this point, as well.

At this point, the sides of the cover 14 may be folded toward the center of the cover, and the crank handle 110 used to wind the cover 14 onto its roller 20. When the cover 14 has been wound completely onto its support roller 20, one of the retainer bungees 114 may be hooked to the crank handle 110 to prevent the cover 14 from unrolling while the eyebolt 74 at the opposite end of the support roller, e.g., the second support extension 72, is withdrawn from its socket at the upper end of the corresponding second upright extension 58. The second support extension 72 is temporarily placed in the crotch or notch 102 at that side of the structure, and the person disassembling the cover assembly 10 returns to the opposite side of the vehicle. The retainer bungee 114 and crank handle 110 are removed, and the support roll 20, its extensions 70 and 72, and the cover 14 wound thereon are removed from the cover frame 12 for storage along with the previously freed anchor bars 26 and 28.

Having accomplished the above, all that remains is to fold the two opposite upright assemblies, i.e., the first and second uprights 44, 46, their extensions 56, 58, and their diagonals 48, 50, downwardly against the frame base member 30, open the doors of the vehicle to release the two retaining straps 90 and 92, and remove the frame assembly 12 from the roof of the vehicle. The frame assembly 12, rolled cover 14, and anchor members 26 and 28 are sufficiently compact when configured for storage to be stored within the trunk of the automobile A or other vehicle, if so desired, allowing the cover assembly 10 to be carried with the vehicle for deployment and use as required.

It is to be understood that the present invention is not limited to the embodiments described above, but encompasses any and all embodiments within the scope of the following claims.

I claim:

1. A vehicle cover, comprising:
a cover support frame having;
a first upright assembly;
a second upright assembly laterally separated from the first upright assembly; and
a cover support removably and rotationally disposed atop the first upright assembly and the second upright assembly;
a laterally disposed forward anchor member;
a laterally disposed rearward anchor member; and
a cover sheet having;
a medial cover support attachment secured to the cover support;
a forward panel removably secured to the forward anchor member; and
a rearward panel removably secured to the rearward anchor member, the forward panel and rearward panel of the cover sheet being selectively wound upon the cover support for storage and deployment thereof.

2. The vehicle cover according to claim 1, further comprising:
a laterally disposed base member having mutually opposed first and second ends;
a first upright support extending forwardly and rearwardly from the first end of the base member, the first upright assembly being pivotally disposed upon the first upright support; and
a second upright support extending forwardly and rearwardly from the second end of the base member, the second upright assembly being pivotally disposed upon the second upright support.

3. The vehicle cover according to claim 1, further comprising:
a laterally disposed base member having mutually opposed first and second ends;
a first upright support extending forwardly and rearwardly from the first end of the base member;
a second upright support extending forwardly and rearwardly from the second end of the base member;
a first upright base tube extending from the first upright support;
a first upright extension telescopically disposed within the first upright base tube;
a second upright base tube extending from the second upright support and laterally separated from the first upright base tube; and
a second upright extension telescopically disposed within the second upright base tube, the cover support being disposed atop the first upright extension and the second upright extension.

4. The vehicle cover according to claim 3, further comprising:
first and second lock rings adjustably disposed respectively about the first upright extension and the second upright extension, the lock rings being selectively canted upon and selectively locking the first upright extension and second upright extension respectively relative to the first upright base tube and the second upright base tube.

5. The vehicle cover according to claim 1, further comprising:
a first supplemental cover support extending angularly from the first upright assembly, the first supplemental cover support and first upright assembly defining a first crotch for temporarily supporting the cover support therein; and
a second supplemental cover support extending angularly from the second upright assembly, the second supplemental cover support and second upright assembly defining a second crotch for temporarily supporting the cover support therein.

6. The vehicle cover according to claim 1, further comprising:
a first door capture anchor strap adjustably extending from the first upright assembly; and
a second door capture anchor strap adjustably extending from the second upright assembly.

7. A vehicle cover, comprising:
a cover support frame, having;
a laterally disposed base member with mutually opposed first and second ends;
a first upright support extending forwardly and rearwardly from the first end of the base member;
a second upright support extending forwardly and rearwardly from the second end of the base member;
a first upright assembly, pivotally disposed upon the first upright support;
a second upright assembly, pivotally disposed upon the second upright support;
a cover support, removably disposed atop the first upright assembly and the second upright assembly;
a cover sheet having;
a medial cover support attachment secured to the cover support;
a forward panel having a distal vehicle front attachment portion; and
a rearward panel having a distal vehicle rear attachment portion.

8. The vehicle cover according to claim 7, further comprising:
a laterally disposed forward anchor member, the forward panel of the cover sheet being removably secured to the forward anchor member;
a laterally disposed rearward anchor member, the rearward panel of the cover sheet being removably secured to the rearward anchor member;
the cover support being removably and rotationally disposed atop the first upright assembly and the second upright assembly; and
the forward panel and rearward panel of the cover sheet being selectively wound upon the cover support for storage and deployment thereof.

9. The vehicle cover according to claim 7, further comprising:
a first upright base tube extending from the first upright support;
a first upright extension, telescopically disposed within the first upright base tube;
a second upright base tube extending from the second upright support and laterally separated from the first upright base tube;
a second upright extension, telescopically disposed within the second upright base tube; and
the cover support being disposed atop the first upright extension and the second upright extension.

10. The vehicle cover according to claim 9, further comprising:
first and second lock rings adjustably disposed respectively about the first upright extension and the second upright extension, the lock rings being selectively canted upon and selectively locking the first upright extension and second upright extension respectively relative to the first upright base tube and the second upright base tube.

11. The vehicle cover according to claim 7, further comprising:
a first supplemental cover support extending angularly from the first upright assembly, the first supplemental cover support and first upright assembly defining a first crotch for temporarily supporting the cover support therein; and
a second supplemental cover support extending angularly from the second upright assembly, the second supplemental cover support and second upright assembly defining a second crotch for temporarily supporting the cover support therein.

12. The vehicle cover according to claim 7, further comprising:
a first door capture anchor strap adjustably extending from the first upright assembly; and
a second door capture anchor strap adjustably extending from the second upright assembly.

13. A vehicle cover, comprising:
a cover support frame having;
a first upright base tube;
a first upright extension, telescopically disposed within the first upright base tube;
a second upright base tube, laterally separated from the first upright base tube;
a second upright extension, telescopically disposed within the second upright base tube;
a cover support, removably disposed atop the first upright extension and the second upright extension;
a cover sheet having;
a medial cover support attachment secured to the cover support;
a forward panel having a distal vehicle front attachment portion; and
a rearward panel having a distal vehicle rear attachment portion.

14. The vehicle cover according to claim 13, further comprising:
a laterally disposed forward anchor member, the forward panel of the cover sheet being removably secured to the forward anchor member;
a laterally disposed rearward anchor member, the rearward panel of the cover sheet being removably secured to the rearward anchor member;
the cover support being removably and rotationally disposed atop the first upright assembly and the second upright assembly; and
the forward panel and rearward panel of the cover sheet being selectively wound upon the cover support for storage and deployment thereof.

15. The vehicle cover according to claim 13, further comprising:
a laterally disposed base member having mutually opposed first and second ends;
a first upright support extending forwardly and rearwardly from the first end of the base member, the first upright base tube being pivotally disposed upon the first upright support; and
a second upright support extending forwardly and rearwardly from the second end of the base member, the second upright base tube being pivotally disposed upon the second upright support.

16. The vehicle cover according to claim 13, further comprising:
first and second lock rings adjustably disposed respectively about the first upright extension and the second upright extension, the lock rings being selectively canted upon and selectively locking the first upright extension and second upright extension respectively relative to the first upright base tube and the second upright base tube.

17. The vehicle cover according to claim 13, further comprising:
a first supplemental cover support extending angularly from the first upright base tube, the first supplemental cover support and first upright base tube defining a first crotch for temporarily supporting the cover support therein; and
a second supplemental cover support extending angularly from the second upright base tube, the second supplemental cover support and second upright base tube defining a second crotch for temporarily supporting the cover support therein.

18. The vehicle cover according to claim 13, further comprising:
a first door capture anchor strap adjustably extending from the first upright base tube; and
a second door capture anchor strap adjustably extending from the second upright base tube.
